(19) United States
(12) Patent Application Publication
(10) Pub. No.: US 2002/0011522 A1
(43) Pub. Date: Jan. 31, 2002

(54) Color change by evaporation for food and beverage and organ protection

(76) Inventor: Nabil M. Lawandy, North Kingston, RI (US)

Correspondence Address: HARRINGTON & SMITH, LLP, 1809 BLACK ROCK TURNPIKE, FAIRFIELD, CT, 06432, US

(21) Appl. No.: 09/860,915

(22) Filed: May 18, 2001

Related U.S. Application Data
(60) Provisional application No. 60/205,341, filed on May 18, 2000.

(51) Int. Cl. G05D 23/00; B32B 23/04; B32B 29/00

(52) U.S. Cl. 236/47; 428/521; 428/532; 62/229

(57) ABSTRACT

A method and apparatus for manifesting the time-temperature history of a perishable object includes the providing the object with a substrate having layer that is comprised of a volatile component and at least one other component, where the volatile component has an evaporation rate related to time and temperature. The teachings herein include allowing the volatile component to evaporate, causing a color change with the remaining component that reflects a time-temperature history of the object. The other component may include a lactone dye or crystal violet lactone, The layer may include poly-p-(hydroxystyrene), ethanol, crystal violet lactone and N-methyl pyrrolidinone, or may include poly-p-(hydroxystyrene), ethanol, crystal violet lactone, ammonia, N-methyl pyrrolidinone, and formaldehyde. A barrier may be provided to control the removal of the volatile component, and at least one chromophore may be provided to bias the layer so as to reduce an amount of time required before the color change is detectable. A dispenser of color change labels is also disclosed, as is a method for applying labels to a perishable object to be monitored.

### CLAIM OF PRIORITY

This patent application claims priority under 35 U.S.C. §119(e) from co-pending U.S. Provisional Patent Application 60/205,341, filed May 18, 2000.

### FIELD OF THE INVENTION

This invention is directed toward providing a time-temperature history of a product and, in particular, toward using the time-temperature history to predict the remaining shelf life of the product.

### BACKGROUND OF THE INVENTION

As is well known, perishable goods such as foods and beverages require refrigeration in order to maintain their integrity. For example, meat that is not maintained in a properly refrigerated environment can become laden with dangerous bacteria such as certain forms of e-coli. Similarly, milk can spoil if not properly refrigerated. Another area where refrigeration is critical is in organ transplants, where donated organs are often transported from one geographic site to another and must be kept refrigerated in order to remain viable for transplantation. Another consideration for perishable goods is the life of the goods, which may be important regardless of the storage temperature. Using the transplanted organ example, the organ may have a very limited “shelf life” regardless of the storage temperature. Foods and beverages may be capable of being stored for longer periods of time, however, there is a point where the food or beverage is no longer consumable regardless of the storage temperature.

A known example of such an indicator is a bacteria-based label product that changes color if the product is left unrefrigerated. This color change indication is created by the growth of bacteria in the unrefrigerated label, which in turn drives a color change.

Objects of the Invention

It is a first object and advantage of these teachings to provide a system and process for providing a time-temperature history of a perishable object.

It is another object and advantage of these teachings to provide a time temperature history of a perishable object utilizing an evaporative technique that manifests a visual indication of the time-temperature history.

### SUMMARY OF THE INVENTION

A method and apparatus for manifesting the time-temperature history of a perishable object includes providing the object with a substrate having layer that is comprised of a volatile component and at least one other component, where the volatile component has an evaporation rate related to time and temperature. The teachings herein include allowing the volatile component to evaporate, causing a color change with the remaining component that reflects a time-temperature history of the object. The other component may include a lactone dye or crystal violet lactone, The layer may include poly-p-(hydroxystyrene), ethanol, crystal violet lactone and N-methyl pyrrolidinone, or may include poly-p-(hydroxystyrene), ethanol, crystal violet lactone, ammonia, N-methyl pyrrolidinone, and formaldehyde. A barrier may be provided to control the evaporation rate of the volatile component, and at least one chromophore may be provided to bias the layer so as to reduce an amount of time required before the color change is detectable. A dispenser of color change labels is also disclosed, as is a method for applying labels to a perishable object to be monitored.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 shows a graph of the relative effect of temperature on the shelf life of a perishable object;

FIG. 2 shows a substrate including a coating in accordance with the teachings found herein;

FIG. 3 illustrates a colorless lactone form and its cationic (colored) form, and is useful in explaining an embodiment of this invention that employs an evaporative technique for manifesting a color change;

FIG. 4 is a graph that illustrates a change in optical absorption as a function of wavelength for an embodiment of a color changing compound (an amino-phthalide dye (SD-3055) in a 4-vinylphenol polymer) in accordance with an aspect of this invention;

FIG. 5 is a graph that plots the time for a color change versus top barrier layer thickness;

FIG. 6 is a graph that shows the use of a bias chromophore to vary a time required for a photoabsorbing layer in accordance with these teachings to reach a visibility threshold;

FIG. 7 is a partially cut-away view of a package containing an substrate having a mechanism for manifesting the time-temperature history of an object that includes a volatile compound, and a source of a color blocking agent (CBA); and

FIG. 8 shows a dispensing system for applying a coating to a substrate in accordance with the teachings found herein.

### DETAILED DESCRIPTION OF THE INVENTION

Although these teachings will be described with reference to the embodiments shown in the drawings, it should be understood that the present invention may be embodied in many forms of alternative embodiments. In addition, any suitable size, shape or type of materials or elements could be used.

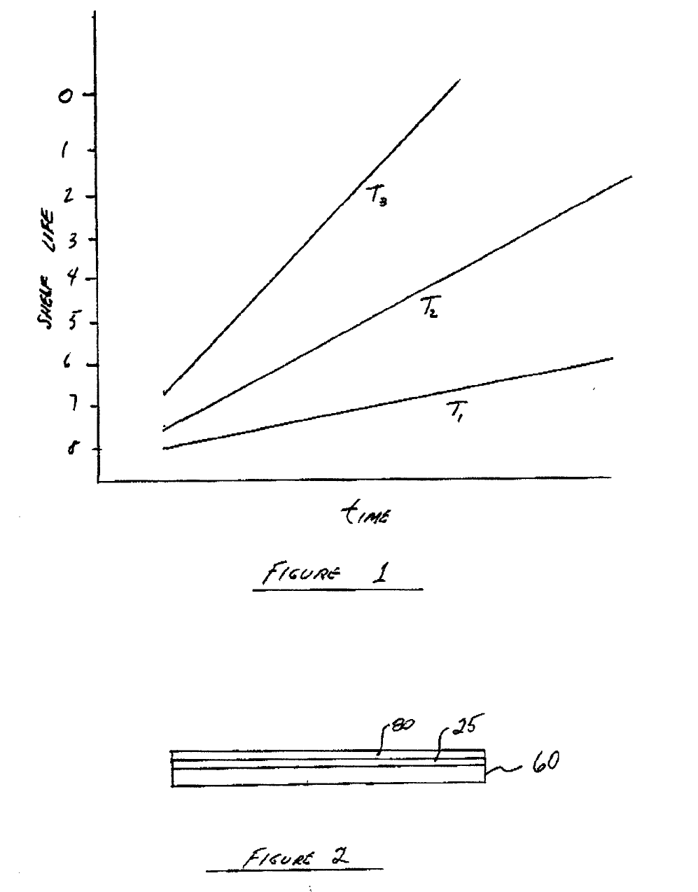

FIG. 1 shows a graph of the relative effect of temperature on the shelf life of a perishable object. As can be seen, subjecting the object to a lower temperature T1 typically results in an extended shelf life, while an object stored at a higher temperatures, T2, T3, experience a shorter shelf life.

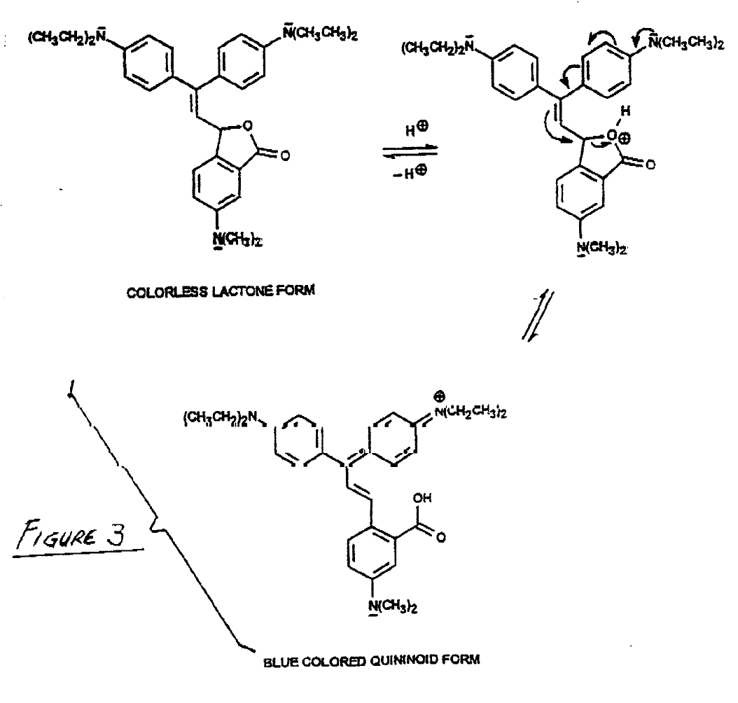

FIG. 2 shows a substrate 60 that includes a coating 25 in accordance with these teachings. The substrate 60 may be embodied in various forms, including a matrix, a label, a sheet of conventional plastic wrap, a tape material with an adhesive, or any other form suitable for supporting the coating 25. The substrate may be fixed or otherwise attached to a perishable object, or may be placed in or otherwise exposed to the environment of the object, in order to indicate the time-temperature history of the perishable object.

The coating 25 may be transparent (e.g., a clear coating) or it may have a predetermined coloration. Over a period of time, and depending on the temperature to which the coating 25 is subjected, the coating 25 changes via an evaporative mechanism to a predetermined color, and thus provides an indication of the time-temperature history of the perishable object.

It should be noted that the substrate may also have a predetermined color, such that together with the color change of coating 25, the manifestation of time-temperature history may include more than one detectable color. For example, the color red could indicate that an object has been subjected to a particular temperature range for three months, while the color blue may indicate that an object has been subjected to a particular temperature range for six months.

In one embodiment the coating 25 includes a dye, such as a lactone dye, having a cation with strong light absorbance properties in the visible range. A polymer material or some other material can be used to provide an acidic pH state for causing a controlled ring opening of the lactone dye, and which can be cross-linked or otherwise modified to form a relatively inert or inactive coating layer.

Lactone dyes are generally colorless so long as the lactone moiety remains intact. However, by modifying a state or condition of the moiety, for example by lowering the pH and/or by changing the micropolarity, the lactone ring is cleaved and the intensely colored cationic form of the dye is obtained.

Referring to FIG. 3, an example of the coating 25 includes at least three components: (1) a dye, such as a lactone type dye; (2) acidic sites; and (3) a solvent, such as an amine or amide-based solvent. The acidic sites may be provided by a polymer, a clay, or by any other acidic substrate. When the components are combined, the amine or amide-based solvent serves to stabilize the lactone dye to the colorless form. When the amide or amine-based solvent evaporates, the lactone group reacts with the acidic sites and undergoes a ring opening to generate a highly colored substance with a strong absorption at about 650 nm.

In greater detail, the colorless lactone shown in the reaction scheme shown in FIG. 3 is protonated by an acid. Each nitrogen is shown with its free electron pair. The protonated lactone undergoes a ring opening to produce the colored compound, in this case, blue, which is in a quininoid form. The electron pairs on the two nitrogens with the ethyl groups are directly involved with the ring opening of the protonated lactone, thereby producing the colored compound in a quininoid form.

The functioning of this color changing system is based on a four component equilibrium. The equilibrium is between the colorless lactone form, the colored quininoid form, and the number of acidic and basic sites associated with the permanent and the volatile components of the color changing system.

In general, the rate of color change is dependent on the type of solvent, its freezing point, its boiling point, and the temperature to which it is exposed during the color change period. By selecting an appropriate solvent, complete color formation can occur within a range of a few minutes to several months, and may be further adjusted to occur within shorter or longer time periods. In addition, proper solvent selection results in a predictable color change that reflects a particular time-temperature history experienced by the coating 25. Moreover, the final maximum absorbance at a particular wavelength can be modified over a range of absorbances by changing the lactone moiety to acidic site ratio.

In other embodiments of these teachings, the polymer provides a basic pH state while the evaporating solvent has an acidic nature. In this case the color change occurs when the system transitions from acidic to basic due to evaporation.

The “undyed” state of the coating 25 may be maintained by storing the substrate 60 in a way that prevents the solvent from evaporating, described in further detail below.

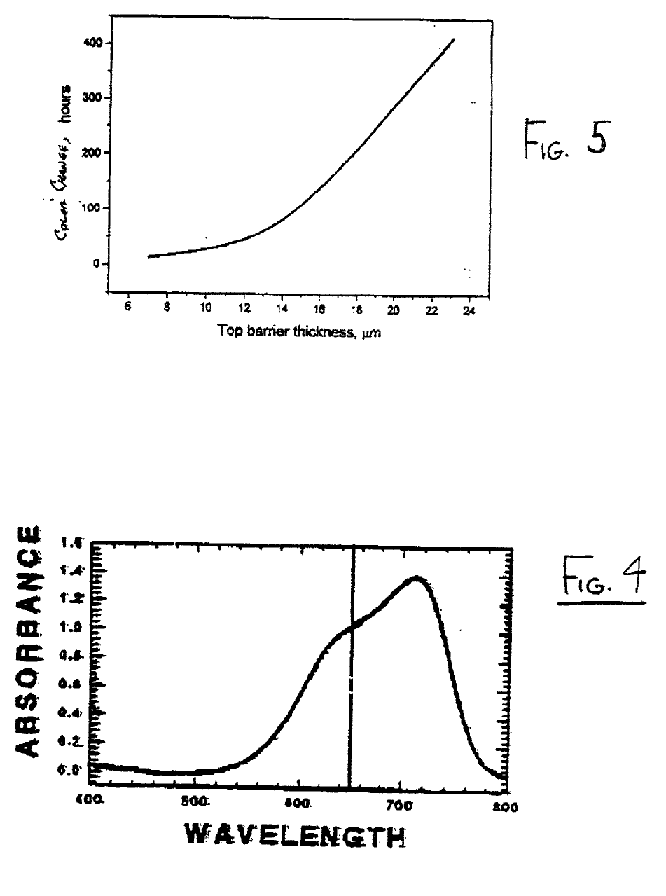

Further in accordance with an embodiment of these teachings an amino-phthalide dye in a 4-vinylphenol polymer (av. MW 8,000) was cross-linked in the presence of formaldehyde. FIG. 4 shows the optical absorbance of this system when coated on a glass plate, and exposed to normal room conditions for 21 hours. The vertical bar represents the absorbance at 650 nm. In other embodiments the crosslinking may be controlled in incremental steps, as the level of cross-linking was found to effect the lactone ring opening. It may further be desirable to employ a phenolformaldehyde resin system with the formaldehyde functionality already chemically linked to the polymer, in order to avoid the use of free formaldehyde. Analogues may also be synthesized with solubility properties tailored to the polymer formulations.

In any of these embodiments the coating 25 may be applied by a spin coating procedure. As an example, for the amino-phthalide dye in the 4-vinylphenol polymer embodiment a layer thickness equal to or less than about one micrometer was found to be optimum.

### EXAMPLE 1

A solution was prepared of 1 g poly(4-vinylphenol) (MW=8,000) in 10 ml ethanol, 2 ml N,N-dirnethylformamide and 200 mg of 3-[2,2-bis(4-diethylarninophenyl)vinyl)-6-dimethylaminophthalide. Glass slides, DVD and CD disks were coated with this formulation to produce a 500-700 nm thick layer. The coating was dried at 60-70 degrees C. for a few minutes, which caused the generation of an intensely blue colored dye. This blue dye was transformed back to its colorless state by exposing the slides or disks to a controlled atmosphere of an amine or amide based solvent (e.g., fonnamides, acetamides, pyrrolidinones). The colorless state was maintained when these slides and disks remained sealed in polyester or polypropylene bags along with an absorbent medium, such as filter paper, that contained a few drops of the corresponding solvent. Upon removal from the bag, color formation occurred again. Depending on the boiling point of the used solvent, the color formation could be timed. For example, with the formulation described in this example, and by using 1-methyl-2-pyrrolidinone as a solvent, a maximum absorbance of 0.7 at 650 nm was achieved after about six hours at room temperature.

### EXAMPLE 2

Modification of the polymer to lactone ratio was found to control the maximum achievable absorbance at a particular wavelength, in this example, 650 nm. It is important not to just increase the concentration of lactone groups, but to also adjust the number of acidic sites available to the lactone moiety. When glass slides and disks were coated with a formulation of 1.5 g poly(4-vinylphenol) (MW=8,000), 10 ml ethanol, 2 ml N,N-dimethylformamide and 300 rng of 3-[2,2-bis(4-diethylarninophenyl)vinyl)-6-dimethylaminophthalide, a maximum absorbance of 1.7 at 650 nm was obtained after about six hours at room temperature.

### EXAMPLE 3:

If high boiling amine or amide-based solvents are used; e.g., b.p.>100_C., the solvent can be added directly to the formulation and exposure of the coating to a controlled solvent atmosphere can be omitted. For example, when slides or disks were coated with a formulation of 1 g poly(4-vinylphenol) (MW=8000), 10 ml ethanol, 2 ml 1-methyl-2-pyrrolidinone and 200 mg of 3-[2,2-bis(4-diethylaminophenyl)vinyl]-6-dimethylaminophthalide, and then dried for 5 minutes at 50_C., a slightly tacky colorless layer was obtained. The color change to blue occurred at the same rate and to the same level of absorbance as described in Example 1 of this embodiment.

Reference in regard to the compounds mentioned above may be had to co-pending U.S. patent application Ser. No. 09/690,405, entitled “Methods and Apparatus for Rendering an Optically Encoded Medium Unreadable,” filed Oct. 17, 2000, the disclosure of which is incorporated by reference insofar as it does not conflict with the teachings found herein.

A further aspect of these teachings is a mechanism to control the duration of the color change. Referring to FIG. 5, a graph is depicted that plots the time to effect a color change (in hours) versus a thickness of a top barrier layer 80 (see FIG. 2) that is placed over the coating 25. An increase in the thickness of the top barrier layer 80 can be seen to increase the amount of time that the coating makes the transition from a transparent to a non-transparent state, as transport of the volatile substance (e.g., the evaporating solvent) through the barrier layer 80 is slowed. In the embodiments of this invention the color change preferably occurs over days, weeks or even months, depending on the characteristics of the object being monitored and the ambient temperature at which the object is stored.

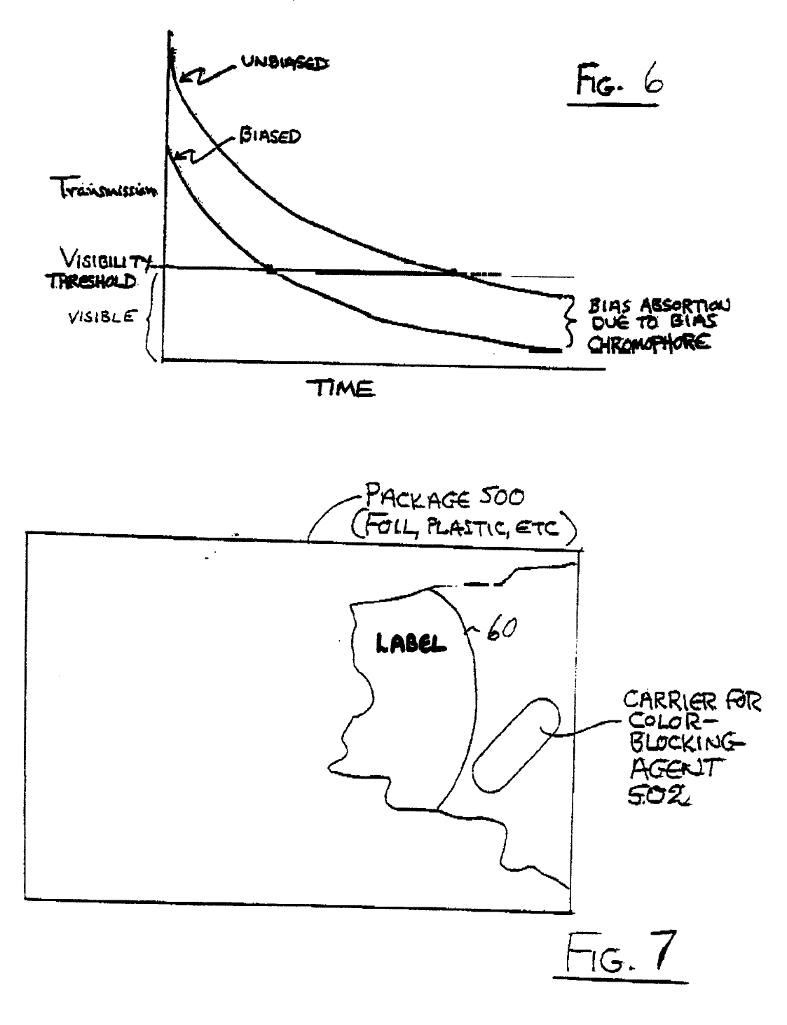

As a further control over the coating color change transition time, and referring also to FIG. 6, the coating 25 can be biased with a chromophore selected to absorb at the desired wavelength, e.g., at about 650 nm. By causing the coating 25 to exhibit some amount of absorption that is less than the amount of absorption that allows the color change to be observed (or “visible,” as in a “visibility threshold”), the time required for the color changing coating to become visible may be reduced. The use of the bias chromophore can also be advantageous to insure that the coating 25 will not asymptotically approach a visibility threshold, without actually crossing it.

One suitable biasing chromophore for the substrate 60 is a dye known as 3-Diethylyamino-7-diethyliminophenoxazonium perchlorate, or Oxazine 725, which has an absorbance maximum at 646 nm in ethanol.

Preferably, the visibility of the coating 25 increases due to the coating 25 turning non-transparent, opaque, or substantially opaque, until it becomes visible. In this regard, it can be appreciated that in a clear state of the coating 25 the color of the underlying substrate 60 may be viewed, and as the color change occurs the underlying substrate color becomes less visible until it is finally obscured. For example, in the initial state a yellow or red color of the underlying substrate 60 may be viewed through the coating(s) 25 and 80, and as time passes the underlying color becomes less prominent, or even changes to another color through color mixing effects with the color change occurring in the coating 25. At the terminal portion of the color cycle, the coating 25 may be dark blue, and may completely obscure the underlying color of the substrate 60.

Further in this regard, it should be noted that it is not necessary in this embodiment, or in any of the other embodiments of these teachings that employ the coating 25, for the coating 25 to be become optically opaque, as the color forming coating may become visible well before a state or condition of optical opacity is reached.

In order to prevent a premature loss of the volatile component by evaporation, the barrier layer 80 can be affixed over the coating 25 as a separate coating, or as a peal-off, removable coating or layer. The barrier layer 80 is one that in one embodiment is impervious to transport of the volatile compound, and thus prevents the evaporation thereof until the barrier layer 80 is removed prior to use. In another embodiment, where the barrier layer 80 is left in place during use, the barrier layer 80 is substantially or slightly or somewhat impenetrable to the volatile component or components that are placed on the substrate 60 (such as the above mentioned solvents in the evaporation embodiments). The barrier layer 80 thus serves to inhibit transport of the volatile component, thereby controlling the rate of evaporation of the volatile component. In one example, the barrier layer 80 is in the form of a peel off sheet. Removal of the peel-off sheet barrier layer 80 after placing the object into storage or refrigeration serves to initiate the color changing process that is indicative of the time-temperature history of the perishable object.

In one embodiment, the barrier layer 80 also serves as a protective layer. In this embodiment the protective barrier layer 80 is comprised of, for example, a UV-curable polymer that can be applied by any suitable technique, such as a spraying procedure, and then UV-cured to harden it. The protective layer polymer material preferably comprises a silicone-based material. It may also comprise epoxy-based constituent(s). The barrier layer 80, as well as the coating 25, can be applied to the substrate 60 by the spraying technique, as well as by spinning-on, or by placing the substrate 60 into an atmosphere that is saturated with the desired constituents, and letting the desired constituents condense onto the substrate 60.

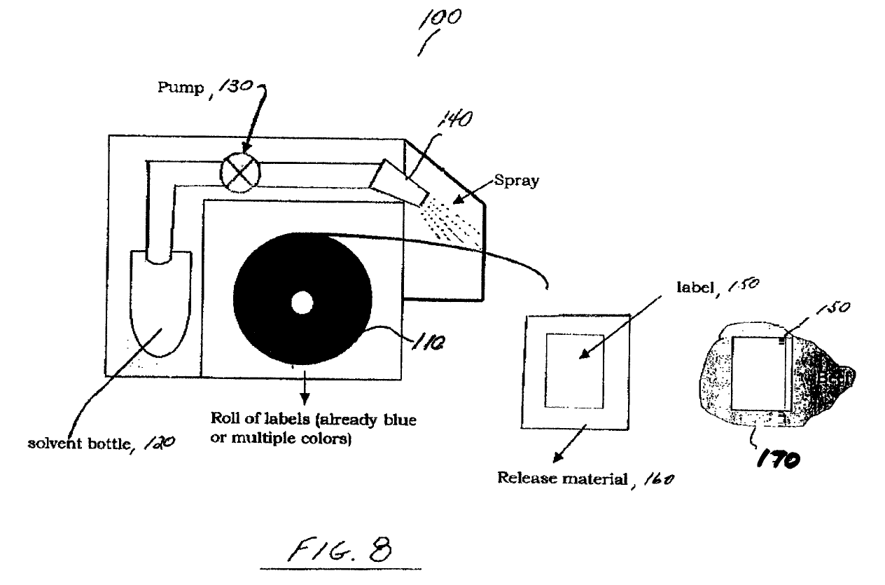

FIG. 7 illustrates a sealed container or package 500, such as a foil or a plastic bag, that is suitable for practicing an aspect of the teachings found herein. The package 500 contains one or more of the color-change substrates 60, such as labels, that include the coating 25, and a carrier or source 502 of a color blocking agent (CBA). The carrier 502 retains the CBA and gradually releases it into the package 500 in the gaseous state. The CBA is delivered to the substrate 60 by means of diffusive transport, where it interacts with the coating 25 to maintain the coating in its transparent or predetermined colored state. This process continues until equilibrium is achieved between the CBA gas and the coating 25, from which point the coating 25 remains in its transparent or predetermined colored state until the package 500 is opened, the substrate 60 (such as an adhesive label or a tag) is removed and then applied to an object to be monitored, such as a food package.

The CBA may be a solid, a liquid or a gas. Examples of release mechanisms include evaporation and diffusion through a membrane. The carrier 502 of the CBA can be implemented as a patch or swab of material with a developed surface (e.g., fibrous or porous), or a CBA-absorbing material, such as a polymer. The CBA release kinetics can be adjusted through various parameters of the carrier 502, such as size and position in the package 500 relative to the substrate 60, and/or through porosity or permeability. The CBA could be the same solvent that forms a part of the coating 25.

Opening of the package 500 results in rapid loss of the CBA from the package, as well as depletion of the CBA carrier 502. The equilibrium between the CBA gas and coating 25 is then permanently shifted towards decreasing CBA concentration, which corresponds to the time remaining before the color change becomes visible. Opening the package 500 triggers the color changing process and thus initiates the monitoring of the time-temperature history of the perishable object.

FIG. 8 shows a dispensing system 100 containing a roll 110 of labels 150, each containing a color change coating 25 on a substrate 60. The substrate 60, in this example, may be an adhesive-backed paper stock.. In other embodiments the labels may be plastic structures attached by an adhesive, or by a clip, or by a tie-on (string or wire), or any suitable device or structure for being attached to a perishable object to be monitored. The labels 150 may already have a color signature produced by application of any of the dye formulations discussed above. A container or bottle 120 holds a supply of a solvent or other volatile component appropriate for use with the particular dye formulation disposed on the roll of labels 110. In one embodiment a manual or electrically actuated pump 130 conveys the solvent through a nozzle 140, and the solvent is deposited by spraying or dripping onto the labels 110. In another embodiment the solvent bottle 120 may communicate with a sponge or a cloth that applies a quantity of the solvent directly to the label 150 as the label 150 is drawn across or against the sponge or cloth, and the pump 130 may be eliminated. In any of these embodiments the amounts of the substance in the layer 25 and/or the solvent may be adjusted so as to provide a predetermined amount of time, at some predetermined storage temperature, before a complete color change occurs. By example, the pump 130 may apply a predetermined, metered amount of solvent to the layer 25. Alternatively, application of the barrier layer 80 may be relied on to set the amount of time over which the complete color range occurs. Application of the solvent results in the color change layer 25 on the substrate 60 achieving a stabilized form, as described above with respect to FIG. 3. For example, the color change layer 25 may initially be blue (i.e., the color change is fully developed), and by applying the solvent the color change is reversed and layer 25 becomes clear or transparent. As was discussed above, the labels 110 may also be packaged to preserve the stabilized form until use.

During use, an individual label 150 is removed from the roll 110, the color change is reversed by application of the solvent, and a backing or release material 160 is removed revealing an adhesive or other material for attaching the label 150 to a perishable object 170. The label 150 is then applied to the perishable object 170, which may be a cut of meat already wrapped in a cellophane wrapper. The label 150 initially shows a clear or predetermined coloration state that changes over time to reflect the time-temperature history of the perishable object 170. After applying the solvent the coating 25 on the label 150 may be overcoated with the barrier layer 80, as described above, to control the evaporation rate of the solvent. It is assumed in at least some of these embodiments that the lower the temperature at which the perishable object 170 is maintained, the slower will be the transport of the solvent out of the color change layer 25.

In various embodiments of these teachings the material that comprises the coating 25 can include a lactone dye, such as crystal violet lactone, poly-p-(hydroxystyrene), ethanol, N-methyl pyrrolidinone and ammonia and formaldehyde, or the material can comprise cellulose acetate butyrate, ethyl acetate, silica gel, and benzyl alcohol, or the material can comprise a salt of a volatile amine, a non-volatile acid component and a lactone dye or a pH indicator dye, or the material can comprise a water damp polymer film containing a pH indicator dye, wherein during storage the layer is exposed to an atmosphere of a gas whose water solution is one of acidic or basic, and wherein upon removal from storage a volatile gas evaporates from the water damp film, and the pH changes causing a color change in the pH indicator dye.

It can be appreciated that a number of embodiments of these teachings have been described herein, and it should be further appreciated that these teachings are not intended to be read in a limiting sense to encompass only these described embodiments.

It is important to note that the biasing chromophores referred to above can be located in the coating 25, and/or in the barrier layer 80, and/or in a third layer.

It is also important to note that the color change described herein may not necessarily be visually detectable under normal lighting conditions. For example, it is contemplated that in at least one embodiment the color change is detectable under ultra-violet illumination and not under normal ambient lighting conditions.

Furthermore, it is within the scope of these teachings to form the color change layer 25 in some predetermined pattern representing a symbol or text, so that the color change makes visible a message to a viewer. As but one example, the color change layer 25 can be applied by printing or through a mask to form characters that, when the color change process is fully developed, read “expired” or some other message indicating that the product should not be purchased and/or that the product should be removed from storage and discarded.

It should thus be apparent that various alternatives and modifications to the presently preferred embodiments of the teachings found herein may be devised by those skilled in the art without departing from these teachings. Accordingly, the teachings herein are intended to embrace all such alternatives, modifications and variances which fall within the scope of the claims.

What is claimed is:

1. A method for manifesting the time-temperature history of a perishable object, comprising:
providing the object with a substrate having a layer that is comprised of a volatile component and at least one other component; said volatile component having an evaporation rate related to time and temperature;
allowing said volatile component to evaporate during storage of the object; and
causing a color change with the remaining component that reflects a time-temperature history of the object.

2. A method as in claim 1, wherein the other component is comprised of a lactone dye.

3. A method as in claim 1, wherein the other component is comprised of crystal violet lactone.

4. A method as in claim 1, wherein the layer is comprised of poly-p-(hydroxystyrene), ethanol, crystal violet lactone and N-methyl pyrrolidinone.

5. A method as in claim 1, wherein the layer is comprised of poly-p-(hydroxystyrene), ethanol, crystal violet lactone, ammonia, N-methyl pyrrolidinone, and formaldehyde.

6. A method as in claim 1, wherein the layer is comprised of cellulose acetate butyrate, ethyl acetate, silica gel, and benzyl alcohol.

7. A method as in claim 1, wherein the layer is comprised of a salt of a volatile amine, a non-volatile acid component and a lactone dye.

8. A method as in claim 1, wherein the layer is comprised of a salt of a volatile amine, a non-volatile acid component and a pH indicator dye.

9. A method as in claim 1, wherein the layer is comprised of a water damp polymer film containing a pH indicator dye, wherein the layer is exposed to an atmosphere of a gas whose water solution is one of acidic or basic, and wherein upon application to the object a volatile gas evaporates from the water damp film, and the pH changes causing a color change in the pH indicator dye.

10. A method as in claim 1, and further comprising providing a barrier over said layer to control an evaporation rate of said volatile component.

11. A method as in claim 1, further comprising providing at least one chromophore that biases said layer so as to reduce an amount of time required before said color change is detectable.

12. A label for indicating a time-temperature history comprising:
a substrate having a layer comprising:
a volatile component having an evaporation rate related to time and temperature; and
at least one other component, wherein evaporation of said volatile component causes a color change with the remaining component that reflects a time-temperature history of said label.

13. A label as in claim 12, wherein the other component is comprised of a lactone dye.

14. A label as in claim 12, wherein the other component is comprised of crystal violet lactone.

15. A label as in claim 12, wherein the layer is comprised of poly-p-(hydroxystyrene), ethanol, crystal violet lactone and N-methyl pyrrolidinone.

16. A label as in claim 12, wherein the layer is comprised of poly-p-(hydroxystyrene), ethanol, crystal violet lactone, ammonia, N-methyl pyrrolidinone, and formaldehyde.

17. A label as in claim 12, wherein the layer is comprised of cellulose acetate butyrate, ethyl acetate, silica gel, and benzyl alcohol.

18. A label as in claim 12, wherein the layer is comprised of a salt of a volatile amine, a non-volatile acid component and a lactone dye.

19. A label as in claim 12, wherein the layer is comprised of a salt of a volatile amine, a non-volatile acid component and a pH indicator dye.

20. A label as in claim 12, wherein the layer is comprised of a water damp polymer film containing a pH indicator dye, wherein prior to use of said label the layer is exposed to an atmosphere of a gas whose water solution is one of acidic or basic, and wherein upon application of the label to an object a volatile gas evaporates from the water damp film, and the pH changes causing a color change in the pH indicator dye.

21. A label as in claim 12, further comprising a barrier over said layer to control the evaporation rate of said volatile component.

22. A label as in claim 12, said layer comprises at least one chromophore that bias said layer so as to reduce an amount of time required before said color change is detectable.

23. An apparatus for dispensing labels for application to objects, comprising:
a supply of labels, each of said labels comprising a layer containing a first component;
an applicator for applying a second component to said layer contained on a label being dispensed from said supply of labels, whereby the combination of the first component and the second component causes a chemical reaction that results in a first visual appearance, said second component being a volatile component that over time evaporates from said layer, resulting in a second visual appearance.

24. An apparatus as in claim 23, wherein each of said labels includes means for attaching said label with an object to be monitored.

25. A method for monitoring the storage time of a perishable object, comprising:
removing a label from a supply of labels;
reversing a color change portion of the label to an initial condition by applying a volatile compound to the color change portion;
attaching the label with a perishable object to be monitored; and
evaporating the volatile component during storage of the perishable object until a predetermined color change is obtained.

26. A method as in claim 25, and further comprising:
overcoating the color change layer with a barrier layer to control the evaporation rate of the volatile component.
